(19) United States
(12) Patent Application Publication
(10) Pub. No.: US 2009/0292065 A1
(43) Pub. Date: Nov. 26, 2009

(54) CAPSULATED COLORANT, METHOD OF PREPARING THE SAME, AND INK COMPOSITION INCLUDING THE CAPSULATED COLORANT

(75) Inventors: Jae-yoon JUNG, SUWON-SI (KR); Seung-min Ryn, GUNPO-SI (KR); Jong-in Lee, SUWON-SI (KR); Sang-eun Shim, INCHEON METROPOLITAN-CITY (KR)

Correspondence Address: DLA PIPER LLP US, P. O. BOX 2758, RESTON, VA, 20195, US

(73) Assignee: SAMSUNG ELECTRONICS CO., LTD., SUWON-SI (KR)

(21) Appl. No.: 12/264,581

(22) Filed: Nov. 4, 2008

(30) Foreign Application Priority Data
May 22, 2008 (KR) 10-2008-0047741

(51) Int. Cl. C08L 63/00; C08L 33/04; C08L 33/02; C08L 9/02; C08L 27/08; C08L 39/00; C08L 25/06

(52) U.S. Cl. 524/548; 524/543; 524/556; 524/565; 524/555; 524/577; 524/568

(57) ABSTRACT

Provided is a capsulated colorant including: a colorant; and a polymer resin coating the colorant, wherein the polymer resin is made by polymerization of a polymerizable composition including a macromonomer and a polymerizable unsaturated monomer. A method of preparing same, and an ink composition comprising the capsulated colorant and a solvent, are also provided. The macromonomer is an emulsion stabilizer when the polymer resin is formed in the water solution.

### CROSS-REFERENCE TO RELATED PATENT APPLICATION

This application claims the benefit of Korean Patent Application No. 10-2008-0047741, filed on May 22, 2008, in the Korean Intellectual Property Office, the disclosure of which is incorporated by reference herein, in its entirety.

### TECHNICAL FIELD

The present composition relates to inks. In particular, it is a capsulated colorant, a method of preparing the same, and an ink composition including the capsulated colorant.

### BACKGROUND

Colorants used in inkjet printers produce their colors by selectively absorbing or reflecting visible light. Colorants are often classified as dyestuffs or pigments. Dyestuffs can be used to color virtually any material such as fibers, leathers, furs and papers. Dyestuffs also provide considerable color fastness with respect to light, rubbing, and the like. Pigments are generally in the form of fine particles. Pigments color a material by being directly adhered by physical means (e.g., adhesion, etc.) to the surface of the material to be dyed.

Dyestuffs are dissolved in solvents such as water. Pigments are generally insoluble in these solvents. Thus, it is important to homogeneously disperse fine pigment particles in a solution and stably maintain the dispersed state without re-aggregation.

A water-soluble dyestuff-type ink has long-term storage stability, maintains homogeneity, and has clear color and brightness. However, it may have poor waterfastness, light resistance, etc.

Pigment-type ink has high optical density (OD), waterfastness and light resistance and little bleeding between colors. However, it may have poor color clearness and poor long-term storage stability compared to dyestuff-type ink. In addition, images printed using pigment-type inks may have poor dry and wet rub fastness. Furthermore, when color printing (multicolor printing) with dyestuffs or pigments, bleeding at interfaces of each color may occur, thereby reducing the clearness of images.

Resin has been added to ink. However, the resin may increase the viscosity of the ink. Further, although resin particles may be added to ink to prevent viscosity of ink from increasing, rub resistance may not be sufficiently improved if the resin particles and the pigments are independently dispersed in the ink.

Other encapsulated colorants may have good printed image quality such as abrasion resistance and waterfastness properties. However, an emulsifier that is commonly used in the process of encapsulation cannot provide permanent dispersion stability of the capsulated colorant in the capsulated colorant solution. This affects the physical properties and reliability of ink through interaction with an organic solvent and an emulsion stabilizer used to prepare ink and generates foam in the ink solution. Thus, if the ink is applied to an ink cartridge, reliability of the ink may be decreased. For example, nozzles may be blocked, physical properties of the ink may be changed, for example, viscosity of ink may be increased and surface tension may be changed over a long period of time due to residual emulsifier, and ejection stability may be decreased due to the generated foam.

### SUMMARY

A capsulated colorant having permanent dispersion stability and a method of preparing the capsulated colorant is provided. The capsulated colorant maintains stable physical properties for a long period of time by substantially, completely, eliminating interactions between an organic solvent and an emulsifier, which are used to prepare ink. It eliminates these interactions by inhibiting the emulsifier from remaining in a capsulated colorant solution. It increases reliability of ink by preventing or reducing foam generation and decreasing nozzle blocking. It produces high quality images having improved waterfastness, light resistance, abrasion resistance, and optical density properties.

The capsulated colorant comprises: a colorant, and a polymer resin coating the colorant, wherein the polymer resin is made by polymerization of a polymerizable composition comprising a macromonomer and a polymerizable unsaturated monomer.

There is also provided a method of preparing a capsulated colorant, the method comprising:

emulsifying a polymerization composition comprising a polymerizable unsaturated monomer, a water-soluble medium, a colorant, a macromonomer, and a polymerization initiator; and

forming a polymer resin coating the colorant by polymerizing the polymerizable unsaturated monomer and the macromonomer on the colorant.

There is also provided an ink composition comprising the capsulated colorant and a solvent.

There is also provided an ink set comprising at least two types of ink compositions comprising the capsulated colorant.

There is also provided a cartridge for an inkjet recording apparatus comprising the ink set.

There is also provided an inkjet recording apparatus comprising the cartridge.

A water-soluble macromonomer including an unsaturated hydrocarbon is used as an emulsion stabilizer to prepare a capsulated colorant coated with a polymer by reacting a colorant with a monomer. Thus, the colorant, which permanently binds to the monomer through copolymerization, has permanent dispersion stability of the emulsion, which is obtained as a result of the copolymerization. The colorant maintains stable physical properties by eliminating interactions between an organic solvent and an emulsifier, which are used to prepare ink. It also inhibits foam formation. An ink composition including the capsulated colorant has waterfastness, light resistance, abrasion resistance, optical density properties, storage stability and prevents nozzle blocking.

### BRIEF DESCRIPTION OF THE DRAWINGS

The above and other features will become more apparent by describing in detail, forms thereof with reference to the attached drawings in which:

FIG. 1 shows a method of preparing a capsulated colorant using a polymerizable unsaturated monomer and a macromonomer;

FIG. 2 is a perspective view of an inkjet recording apparatus including an ink cartridge;

FIG. 3 is a cross-sectional view of an ink cartridge;

FIG. 4 is a transmission electron microscopy (TEM) image of the capsulated colorant prepared according to Example 1-2;

FIG. 5 is a graph of particle size distribution of a capsulated colorant prepared according to Example 1-2;

FIG. 6 is a TEM image of a capsulated colorant prepared according to Examples 1-6:

FIG. 7 is a graph of particle size distribution of a capsulated colorant prepared according to Example 1-6;

FIG. 8 is a TEM image of a capsulated colorant prepared according to Example 1-11;

FIG. 9 is a graph of particle size distribution of a capsulated colorant prepared according to Example 1-11;

FIG. 10 is a TEM image of a capsulated colorant prepared according to Example 1-15; and

FIG. 11 is a graph of particle size distribution of a capsulated colorant prepared according to Example 1-15.

### DETAILED DESCRIPTION OF THE DRAWINGS

It will be appreciated that the following description is intended to refer to specific examples of structure selected for illustration in the drawings and is not intended to define or limit the disclosure, other than in the appended claims.

A capsulated colorant including: a colorant; and a polymer resin coating the capsulated colorant, wherein the polymer resin is a result of polymerization of a polymerizable composition comprising a macromonomer and a polymerizable unsaturated monomer, is provided.

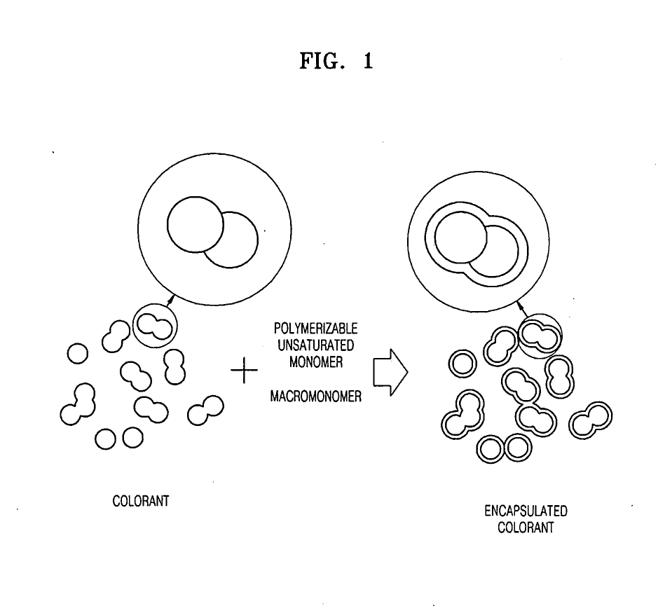

FIG. 1 shows a method of preparing a capsulated colorant using a polymerizable unsaturated monomer and a macromonomer. Referring to FIG. 1, a polymerizable monomer and a macromonomer are polymerized on the surface of a colorant, and a polymer resin, which is a resultant of the polymerization, encapsulates the colorant.

The colorant used herein may be a dyestuff or a pigment, but is not limited thereto, and any colorant that is commonly used in the art may be used. That is, direct dyes acid dyes, edible dyes, alkali dyes, reactive dyes, dispersing dyes, oil dyes, various pigments, self-dispersing pigments, or a mixture thereof can be used for the colorant.

Examples of the dyestuff include food black dyes, food red dyes, food yellow dyes, food blue dyes, acid black dyes, acid red dyes, acid blue dyes, acid yellow dyes, direct black dyes, direct blue dyes, direct yellow dyes, anthraquinone dyes, monoazo dyes, disazo dyes, and phthalocyanine derivatives, but are not limited thereto. Examples of the pigments include carbon black, graphite, vitreous carbon, activated charcoal, activated carbon, anthraquinone, phthalocyanine blue, phthalocyanine green, diazos, monoazos, pyranthrones, perylene, quinacridone, and indigoid pigments, and examples of the self-dispersing pigments include cabojet-series, CW-series of Orient Chemical, but are not limited thereto.

The polymer resin coating the colorant may be prepared by polymerizing a composition including a polymerizable unsaturated monomer and a macromonomer.

In this regard, the polymerizable unsaturated monomer may be at least one selected from the group consisting of a compound having at least two double bonds, unsaturated carboxylic acid, vinyl cyanide monomer, unsaturated carboxylic acid alkyl ester, unsaturated carboxylic acid hydroxyalkyl ester, unsaturated carboxylic acid amide, aromatic vinyl monomer, vinyl lactam, methyl vinyl ketone, vinylidene chloride, unsaturated amine, unsaturated pyridine, unsaturated azole, and a derivative thereof.

As the polymerizable unsaturated monomer, the compound having at least two double bonds may be at least one of butadiene and pentadiene; the unsaturated carboxylic acid may be at least one selected from the group consisting of methacrylic acid, acrylic acid, itaconic acid, crotonic acid, fumaric acid and maleic acid; the unsaturated polycarboxylic acid alkyl ester may be at least one selected from the group consisting of itaconic acid monoethyl ester, fumaric acid monobutyl ester and maleic acid monobutyl ester; the vinyl cyanide monomer may be acrylonitrile or methacrylonitrile; the unsaturated carboxylic acid amide may be acryl amide, methacryl amide, itaconic amide or maleic acid mono amide; and the aromatic vinyl monomer may be styrene, α-methylstyrene, vinyl toluene or P-methylstyrene, but they are not limited thereto.

The macromonomer may be a water-soluble polymer including an unsaturated hydrocarbon, and more particularly, a water-soluble polymer including an unsaturated hydrocarbon which can participate in polymerization at one end of the water-soluble polymer. The macromonomer may be at least one selected from the group consisting of an unsaturated polyethylene glycol based compound, an unsaturated polyester based compound, an unsaturated acrylate based compound, an unsaturated polyamide based compound, an unsaturated epoxy resin based compound, an unsaturated polystyrene based compound, and an unsaturated fatty acid based compound.

In particular, the unsaturated polyethylene glycol base compound includes unsaturated polyethylene glycol and a derivative thereof, and may be polyethylene glycol (PEG)-methacrylate, polyethylene glycol (PEG)-ethyl ether methacrylate, polyethylene glycol (PEG)-dimethacrylate, polyethylene glycol (PEG)-modified urethane, polyethylene glycol (PEG)-modified polyester, polyethylene glycol (PEG)-hydroxyethyl methacrylate, polyethylene glycol (PEG)-polystyrene, polyethylene glycol (PEG)-methacrylic silicon, or a derivative thereof, but is not limited thereto.

The unsaturated polyester-based compound includes an unsaturated polyester and a derivative thereof, and may be polyester acrylate, hexafunctional polyester acrylate, dendritic polyester acrylate, carboxy polyester acrylate, polyester methacrylate, or a derivative thereof, but is not limited thereto.

The polyacrylate based compound includes polyacrylate and a derivative thereof, and may be polymethyl methacrylate, polystyrene-acrylonitrile, polybutylacrylate, polyisobutylmethacrylate, or a derivative thereof, but is not limited thereto.

The unsaturated fatty acid-based compound includes unsaturated fatty acid and a derivative thereof, and may be fatty-acid-modified epoxy acrylate, but is not limited thereto.

The macromonomer may be at least one selected from the group consisting a of polyethylene glycol (PEG)-methacrylate, polyethylene glycol (PEG)-ethyl ether methacrylate, polyethylene glycol (PEG)-polystyrene, polyethylene glycol (PEG)-methacrylic silicon, polyethylene glycol (PEG)-dimethacrylate, polyethylene glycol (PEG)-modified urethane, polyethylene glycol (PEG)-modified polyester, polyacryl amide (PAM), polyethylene glycol (PEG)-hydroxyethyl methacrylate, hexafunctional polyester acrylate, dendritic polyester acrylate, carboxy polyester acrylate, fatty acid modified epoxy acrylate, and polyester methacrylate.

In addition, a method of preparing a capsulated colorant is also provided. The method includes: emulsifying a polymerization composition including a polymerizable unsaturated monomer, a water-soluble medium, a colorant, a macromonomer, and a polymerization initiator; and forming a polymer resin coating the colorant by polymerizing the polymerizable unsaturated monomer and the macromonomer on the colorant.

The macromonomer is mixed with at least one polymerizable monomer. The amount of the macromonomer may be in the range of 1 to 150 parts by weight, and preferably 5 to 100 parts by weight, based on 100 parts by weight of the polymerizable unsaturated monomer. If the amount of the macromonomer is less than 1 part by weight based on 100 parts by weight of the polymerizable unsaturated monomer, the colorant may clog or form a polymer because emulsibility of the macromonomer is decreased. On the other hand, if the amount of the macromonomer is greater than 150 parts by weight based on 100 parts by weight of the polymerizable unsaturated monomer, optical density may be decreased because permeation of the capsulated colorant is increased in paper.

The water-soluble medium may be water or a mixture of water and an organic solvent. The amount of the water-soluble medium may be in the range of 500 to 5,000 parts by weight, and preferably 1,000 to 3,000 parts by weight, based on 100 parts by weight of the polymerizable unsaturated monomer. If the amount of the water-soluble medium is less than 500 parts by weight based on 100 parts by weight of the polymerizable unsaturated monomer, the reaction is performed too quickly, and thus the coated resin may be too thick. On the other hand, if the amount of the water-soluble medium is greater than 5,000 parts by weight based on 100 parts by weight of the polymerizable unsaturated monomer, the monomer cannot be easily transferred to each of the reaction sites, and thus the reaction is performed too slowly and the resin may not be properly coated.

The colorant may be direct dyes, acid dyes, edible dyes, alkali dyes, reactive dyes, dispersing dyes, oil dyes, various pigments, self-dispersing pigments, or a mixture thereof as described above.

The amount of the colorant may be in the range of 100 to 300 parts by weight, and preferably 150 to 250 parts by weight, based on 100 parts by weight of the polymerizable unsaturated monomer. If the amount of the colorant is less than 100 parts by weight based on 100 parts by weight of the polymerizable unsaturated monomer, too much resin is coated oil the colorant, and thus the colorant may agglomerate and storage stability may be decreased. If the amount of the colorant is greater than 300 parts by weight based on 100 parts by weight of the polymerizable unsaturated monomer, not enough resin is coated on the colorant, and thus fixing properties may be decreased.

The emulsification may be direct emulsification in which a colorant dispersion is emulsified in a polymerizable unsaturated monomer and in a water-soluble medium including a macromonomer (a macroemulsifier) using a homogenizer such as a homo mixer, a line mixer or a high pressure homogenizer, or natural emulsification in which a macromonomer is added to a colorant dispersion in a polymerizable unsaturated monomer and the mixture is poured into a large amount of water.

In addition, phase transition emulsification, in which a macromonomer is added to a colorant dispersion in a polymerizable unsaturated monomer and water is added thereto by small amount while stirring the mixture, may be used.

The polymerization initiator may be a water-soluble or oil-soluble persulfate, a peroxide, an azo compound, or a redox composition of a peroxide, for example, a redox composition including phosphorous acid salt. Examples of the polymerization initiator are ammonium persulfate, potassium persulfate, sodium persulfate, hydrogen peroxide, t-butyl hydroxy peroxide, t-butyl peroxy benzoate, 2,2-azobis-isobutyronitrile, 2,2-azobis(2-diaminopropane)hydrochloride and 2,2-azobis(2,4-dimethylvaleronitrile).

The amount of the polymerization initiator may be in the range of 1 to 30 parts by weight, and preferably 5 to 20 parts by weight based on 100 parts by weight of the polymerizable unsaturated monomer. When the amount of the polymerization initiator is less than 1 part by weight, reaction may not be smoothly initiated and reaction may be performed too slowly. On the other hand, when the amount of the polymerization initiator is greater than 30 parts by weight, the reaction may be performed too fast to control the reaction velocity.

The polymerization initiator may be added to the polymerization reaction with other ingredients such as the polymerizable unsaturated monomer, the water-soluble medium, the colorant, and the crosslinkable monomer, in the initial stage of the reaction, or added thereto after emulsifying the other ingredients and heating the mixture. Here, the reaction velocity may not be easily controlled when the polymerization initiator is added in the initial stage of the reaction but the reaction velocity is easily controlled when the polymerization initiator is added after emulsification

In addition, if desired, the polymerization composition may further include additives such as a UV absorber, an antioxidant, a color developer, and a chain transfer agent.

A crosslink degree of the polymer resin, which is contained in the capsulated colorant, can be controlled by regulating the amount and ways of adding the chain transfer agent. Also provided is an ink composition including the capsulated colorant, an organic solvent, and water.

In the ink composition, the amount of the capsulated colorant may be in the range of 1 to 20 parts by weight, preferably 2 to 7 parts by weight, and more preferably 3 to 5 parts by weight, based on 100 parts by weight of the ink composition.

If the amount of the capsulated colorant is less than 1 part by weight based on 100 parts by weight of the ink composition, desired optical density may not be obtained. On the other hand, if the amount of the capsulated colorant is greater than 20 parts by weight based on 100 parts by weight of the ink composition, viscosity of the ink composition is increased too high and ejecting efficiency may be decreased.

The solvent used in the ink composition may be a water-based solvent, and may further include at least one organic solvent. The amount of the solvent may be in the range of 80 to 99 parts by weight, preferably 83 to 95 parts by weight, and more preferably 85 to 93 parts by weight, based on 100 parts by weight of the ink composition.

If the amount of the solvent is less than 80 parts by weight based on 100 parts by weight of the ink composition, viscosity of the ink composition is too high and ejecting efficiency may be decreased. On the other hand, if the amount of the solvent is greater than 99 parts by weight based on 100 parts by weight of the ink composition, surface tension of the ink composition is increased and thus ejecting efficiency can be decreased.

The organic solvent that is included in the solvent may be at least one of a monohydric alcohol based solvent, a ketone based solvent, an ester based solvent, a polyhydric alcohol based solvent, a nitrogen-containing solvent, and a sulfur-containing solvent.

The monohydric alcohol based solvent may be methyl alcohol, ethyl alcohol, n-propyl alcohol, isopropyl alcohol, n-butyl alcohol, sec-butyl alcohol, t-butyl alcohol or isobutyl alcohol, but is not limited thereto. The ketone based solvent may be acetone, methylethyl ketone, diethyl ketone or diacetone alcohol, but is not limited thereto. The ester based solvent may be methyl acetate, ethyl acetate or ethyl lactate, but is not limited thereto. The polyhydric alcohol based solvent may be ethylene glycol, diethylene glycol, triethylene glycol, propylene glycol, butylene glycol, 1,4-butandiol, 1,2,4-butanetriol, 1,5-pentanediol, 1,2,6-hexanetriol, hexylene glycol, glycerol, glycerol ethoxylate or trimethylol propane ethoxylate, but is not limited thereto.

In particular, the monohydric alcohol controls surface tension of ink, and thus can improve permeation and dot formation properties in a recording medium such as paper for professional or nonprofessional use and drying properties of the printed image. The polyhydric alcohol and its derivatives are not easily evaporated, and lower the freezing point of the ink, and thus can improve storage stability of the ink to prevent nozzles from being blocked.

Examples of the nitrogen-containing compound are 2-pyrrolidone and N-methyl-2-pyrrolidone, and examples of the sulfur-containing compound are dimethyl sulfoxide, tetramethyl sulfone and thioglycol.

When the organic solvent is used together with the water-based solvent, the amount of the organic solvent may be 0.1 to 130 parts by weight, and preferably 10 to 50 parts by weight, based on 100 parts by weight of water. When the amount of the organic solvent is less than 0.1 parts by weight based on 100 parts by weight of water, surface tension of ink is excessively increased. On the other hand, when the amount of the solvent is greater than 130 parts by weight based on 100 parts by weight of water, viscosity of the ink composition is too high and ejecting, efficiency may be decreased.

An ink composition may further include various additives to improve properties of the ink composition, and more particularly may include at least one additive selected from the group consisting of a wetting agent, a dispersing agent, a surfactant, a viscosity modifier, a pH regulator, and an antioxidizing agent. The amount of the additives may be in the range of 0.5 to 600 parts by weight, and preferably 10 to 300) parts by weight, based on 100 parts by weight of the colorant. When the amount of the additives is less than 0.5 parts by weight based on 100 parts by weight of the colorant, the effect of the additives may not be provided. On the other hand, when the amount of the additives is greater than 600 pails by weight based on 100 parts by weight of the colorant, storage stability may be decreased.

In particular, the surfactant may be an ampholytic, anionic, a cationic or a nonionic surfactant, and any surfactant may be used according to its purposes without limitation. The surfactant may be used alone or in a combination of at least two of the surfactants above.

Examples of the ampholytic surfactant include alanine, dodecyldi(aminoethyl)glycine, di(octylaminoethyl)glycine, and N-alkyl-N,N-dimethyl ammonium betane.

Examples of the anionic surfactant include alkylbenzene sulfonate, α-olefin sulfonate, polyoxyethylenealkyl ether acetate and phosphate ester.

Examples of the cationic surfactant include: an amine salt surfactant such as alkyl amine salt, aminoalcohol fatty acid derivatives, polyamine fatty acid derivatives and imidazoline, and a quaternary ammonium salt surfactant such as alkyltrimethyl ammonium salt, dialkyldimethyl ammonium salt, alkyldimethyl benzylammonium salt, pyridinium sail alkylisoquinolinium salt and benzethonium chloride salt.

Examples of the nonionic surfactant include polyoxyethylenealkylether surfactant, polyoxyethylenealkylphenylether surfactant and acetylene glycol surfactant.

Among these surfactants, the nonionic surfactant is preferable since it has excellent antifoaming properties.

The nonionic surfactant may be SURFYNOL of Air Products, Inc. having an acetylenic ethoxylated diol structure, TERGITOL of Union Carbide corporation having a polyethylene oxide or polypropylene oxide structure, Tween having a polyoxyethylene sorbitan fatty acid ester structure, or the like.

An ink composition may have a surface tension of 15 to 70 dyne/cm, preferably 25 to 55 dyne/cm at 20° C., and a viscosity of 1 to 20 cps, preferably 1.5 to 3.5 cps at 20° C., in order to have optimized properties. When the surface tension is not within the range above, printing efficiency may suffer, and when the viscosity is not within the range above, ejection may be hindered.

Also provided is an ink set including at least two ink compositions. The ink set can be used in an ink receiving unit of an inkjet recording apparatus or a cartridge for an inkjet printer. An inkjet recording, apparatus may include a thermal head from which ink droplets are ejected by vapor pressure obtained from heating the ink composition, a piezo head from which ink droplets are ejected by a piezo device, a disposable head or a permanent head. In addition, the inkjet recording apparatus can be a scanning type printer or an array type printer, and may be used for a desktop, textile and industrial purpose. These head types, printer types and uses of the inkjet recording apparatus are described for illustrative, purposes only, and the use of the inkjet recording apparatus is not limited thereto.

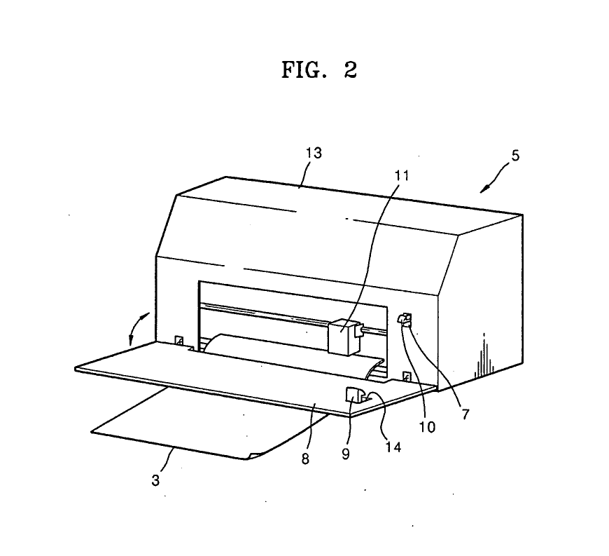

FIG. 2 is a perspective view of an inkjet recording apparatus 5. The inkjet recording apparatus 5 includes an inkjet printer cartridge 11 having an ink composition that contains a macrochromophore colorant and pseudo-colorant additives. A printer cover 8 is connected to a main body 13 of the inkjet recording apparatus 5. An engaging portion of a movable latch 10 protrudes through a hole 7. The movable latch 10 engages with a fixed latch 9 that is coupled to an inner side of the printer cover 8 when the printer cover 8 is closed. The printer cover 8 has a recess 14 in a region corresponding to the engaging portion of the movable latch 10 protruding through the hole 7. The inkjet printer cartridge 11 is positioned such that ink can be ejected onto paper 3 that passes under the ink cartridge 11.

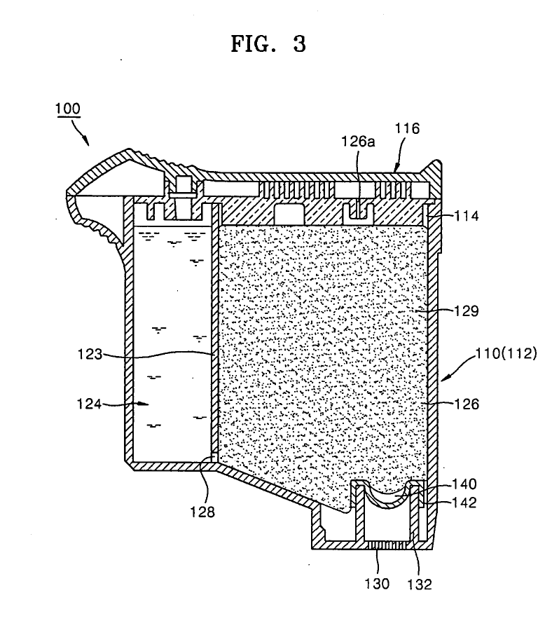

FIG. 3 is a cross-sectional view of an ink cartridge 100 including an ink set. Referring to FIG. 3, the ink cartridge 100 includes an ink cartridge main body 110 including an ink storage tank 112 an inner cover 114 covering a top portion of the ink storage tank 112, and an outer cover 116 that is separated by a predetermined gap from the inner cover 114 and seals the ink storage tank 112 and the inner cover 114.

The ink storage tank 112 is divided into a first chamber 124 and a second chamber 126 by a vertical barrier wall 123. An ink passage 128 is formed between the first chamber 124 and the second chamber 126 in a bottom portion of the vertical barrier wall 123. The first chamber 124, the sponge 129, and the second chamber 126 are filled with ink. A bent hole 126a corresponding to the second chamber 126 is formed in the inner cover 114.

In addition, a filter 140 is disposed in a lower portion of the second chamber 126, so that ink impurities and fine bubbles are filtered to prevent ejection holes of a printer head 130 from being blocked. A hook 142 is formed in the edge of the filter 140 and is coupled to a top portion of a standpipe 112. Thus, ink is ejected from the ink storage tank 112 onto a printing medium in a liquid-drop form through the ejection holes of the printer head 130.

Hereinafter, will be provided the following examples and comparative examples for illustrative purposes.

Preparation of Capsulated Colorant Using Macromonomer

### EXAMPLES 1-1 TO 1-4

### Change of Amount of Macromonomer

Capsulated colorants were prepared as listed in Table 1 below according to a method, which will be described below.

A quantified carbon black dispersion (net amounts of carbon black are shown in Table 1) and 90 g of water were added to a reactor and quantified PEG-ethyl ether methacrylate as a macromonomer was added thereto, and then the mixture was dispersed by stirring. Then, a quantified monomer mixture was added thereto and the mixture was emulsified using ultrasonic waves (or by stirring) for 5 minutes. The temperature of the reactor was increased wider a nitrogen atmosphere. When the temperature reached the polymerization temperature (80° C.), a solution including an initiator (potassium persulfate (KPS)) dissolved in 10 g of water was added to the reactor to initiate polymerization. The polymerization was performed at a stirring rate of 350 rpm for 24 hours under a nitrogen atmosphere to prepare capsulated colorants.

Average particle sizes of the prepared capsulated colorants were measured using a particle size analyzer (Model No.: ELS-Z2 plus, Otsuka Corporation), and the prepared capsulated colorants were dried to measure morphology of the prepared capsulated colorants using transmission electron microscopy (TEM, Japan Electronic Optics Laboratory Ltd. (JEOL Ltd.)) images of the capsulated colorants.

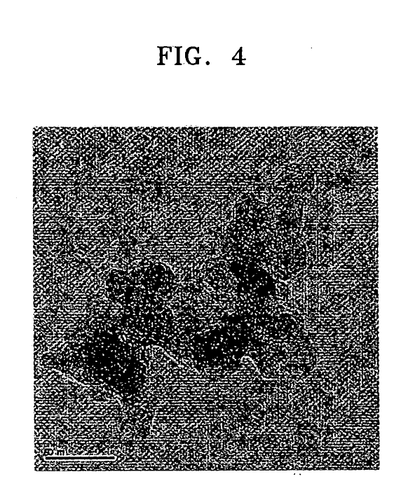

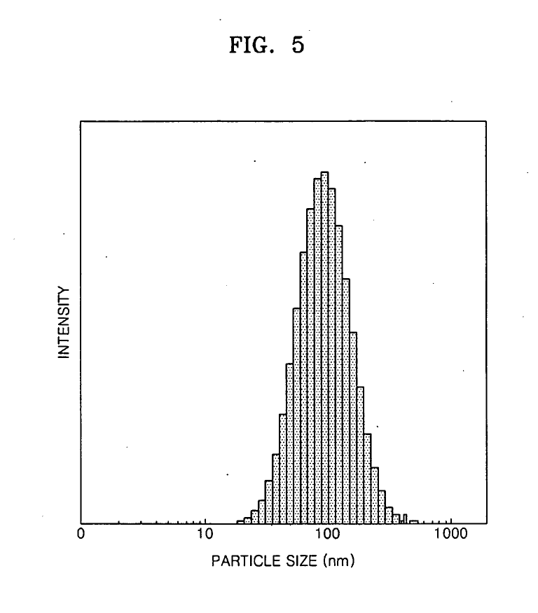

A TEM image and particle size distribution (average particle size: 105.3 nm) of the capsulated colorant prepared according to Example 1-2 are shown in FIGS. 4 and 5, respectively.

TABLE 1

| | Example | | | |
|---|---|---|---|---|
| | 1-1 | Example 1-2 | Example 1-3 | Example 1-4 |
| Carbon black (g) | 10 | 10 | 10 | 10 |
| Styrene (g) | 2.5 | 2.5 | 2.5 | 2.5 |
| Butylacrylate (g) | 2.5 | 2.5 | 2.5 | 2.5 |
| KPS (g) | 0.05 | 0.05 | 0.05 | 0.05 |
| Water (g) | 100 | 100 | 100 | 100 |
| PEG-ethyl ether | 0.5 | 1.0 | 2.0 | 5.0 |
| methacrylate (g) | | | | |

### EXAMPLES 1-5 TO 1-8

### Change of Weight Rate of Carbon Black and Monomer

Capsulated colorants were prepared as listed in Table 2 below according to a method, which will be described below.

A quantified carbon black dispersion (net amounts of carbon black are shown in Table 2) and 90 g of water were added to a reactor, and a quantified macromonomer was added thereto, and then the mixture was dispersed by stirring. Then, a quantified monomer mixture was added thereto and the mixture was emulsified using ultrasonic waves (or by stirring) for 5 minutes. Here, the weight ratio between the carbon black and the monomer was changed from 1:1 to 2.5:1, and the amount of the initiator was adjusted according to the changed amount of the monomer (the amount of the initiator is 1 wt % of the weight of the monomer). The temperature of the reactor was increased under a nitrogen atmosphere. When the temperature reached the polymerization temperature (80° C.), a solution including an initiator (KPS) dissolved in 10 g of water was added to the reactor to initiate polymerization. The polymerization was performed at a stirring rate of 350 rpm for 24 hours under a nitrogen atmosphere to prepare capsulated colorants.

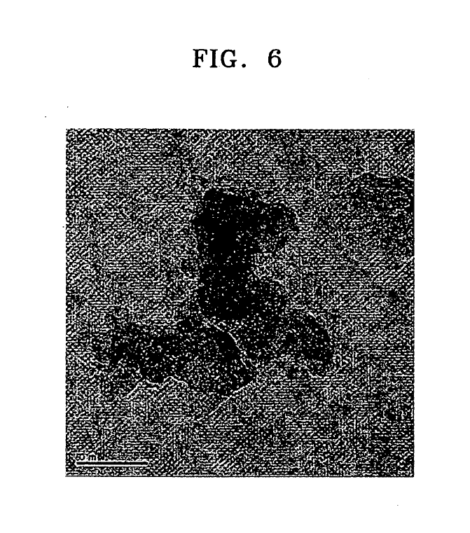

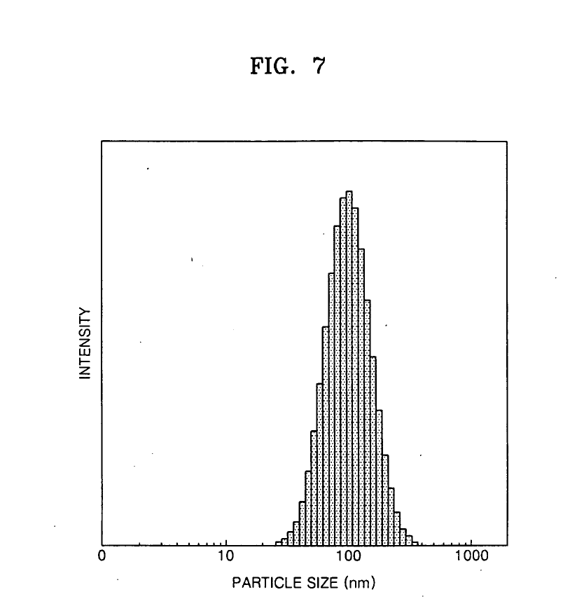

A TEM image and particle size distribution (average particle size: 109.3 nm) of the capsulated colorant prepared according to Example 1-6 are shown in FIGS. 6 and 7, respectively.

TABLE 2

| | Example | | | |
|---|---|---|---|---|
| | 1-5 | Example 1-6 | Example 1-7 | Example 1-8 |
| Carbon black (g) | 10 | 10 | 10 | 10 |
| Styrene (g) | 5.0 | 3.3 | 2.5 | 2.0 |
| Butylacrylate (g) | 5.0 | 3.3 | 2.5 | 2.0 |
| KPS (g) | 0.1 | 0.066 | 0.05 | 0.04 |
| Water (g) | 100 | 100 | 100 | 100 |
| PEG-ethyl ether | 1.0 | 1.0 | 1.0 | 1.0 |
| methacrylate (g) | | | | |

### EXAMPLES 1-9 TO 1-12

### Change of Amount of Carbon Black in the Total Weight

Capsulated colorants were prepared as listed in Table 3 below according to a method, which will be described below.

A carbon black dispersion (net amounts of carbon black are shown in Table 3) having 5-20 wt % of a solid was added to a reactor and a quantified macromonomer was added thereto, and then the mixture was dispersed by stirring. Then, a quantified monomer mixture was added thereto and the mixture was emulsified using ultrasonic waves (or by stirring) for 5 minutes. The temperature of the reactor was increased under a nitrogen atmosphere. When the temperature reached the polymerization temperature (80° C.), a solution including an initiator (KPS) dissolved in 10 g of water was added to the reactor to initiate polymerization. The polymerization was performed at a stirring rate of 350 rpm for 24 hours under a nitrogen atmosphere to prepare capsulated colorants.

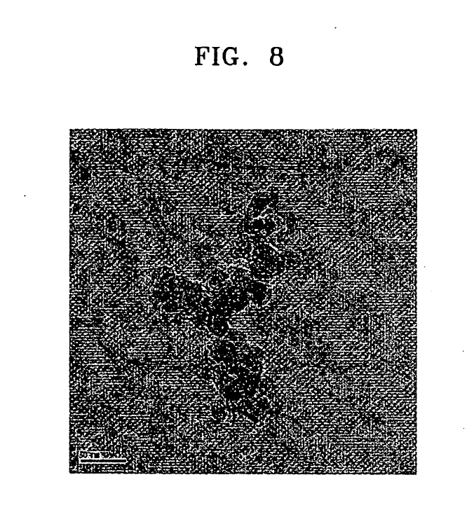

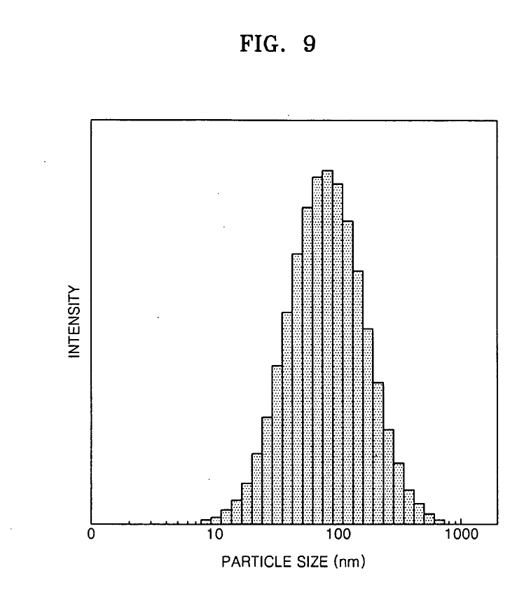

A TEM image and particle size distribution (average particle size, 104.1 nm) of the capsulated colorant prepared according to Example 1-11 are shown in FIGS. 8 and 9, respectively.

TABLE 3

| | | Example | Example | |
|---|---|---|---|---|
| | Example 1-9 | 1-10 | 1-11 | Example 1-12 |
| Carbon black (g) | 5 | 10 | 15 | 20 |
| Styrene (g) | 2.5 | 2.5 | 2.5 | 2.5 |
| Butylacrylate (g) | 2.5 | 2.5 | 2.5 | 2.5 |
| KPS (g) | 0.05 | 0.05 | 0.05 | 0.05 |
| Water (g) | 100 | 100 | 100 | 100 |
| PEG-ethyl ether | 1.0 | 1.0 | 1.0 | 1.0 |
| methacrylate (g) | | | | |

### EXAMPLES 1-13 TO 1-15

### Change of Types of Macromonomer

Capsulated colorants were prepared as listed in Table 4 below according to a method which will be described below.

A quantified carbon black dispersion (net amounts of carbon black are shown in Table 4) and 90 g of water were added to a reactor, and different types of quantified macromonomers were added thereto, and then the mixture was dispersed by stirring. Then, a quantified monomer mixture was added thereto and the mixture was emulsified using ultrasonic waves (or by stirring) for 5 minutes. The macromonomer was PEG-ethyl ether methacrylate, PEG-polystyrene, or PEG-methacrylic silicon. The temperature of the reactor was increased under a nitrogen atmosphere. When the temperature reached the polymerization temperature (80° C.), a solution including an initiator (KPS) dissolved in 10 g, of water was added to the reactor to initiate polymerization. The polymerization was performed at a stirring rate of 350 rpm for 24 hours under a nitrogen atmosphere to prepare capsulated colorants.

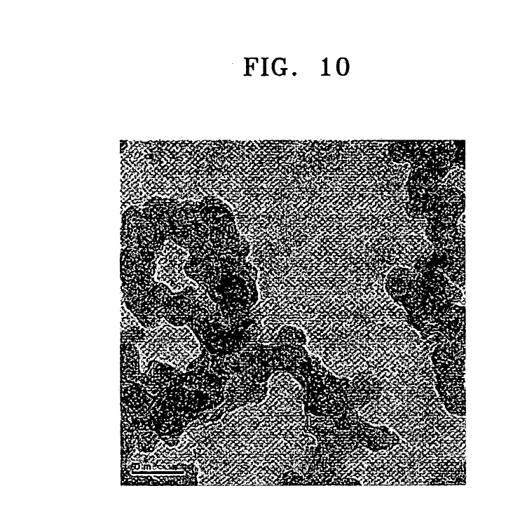

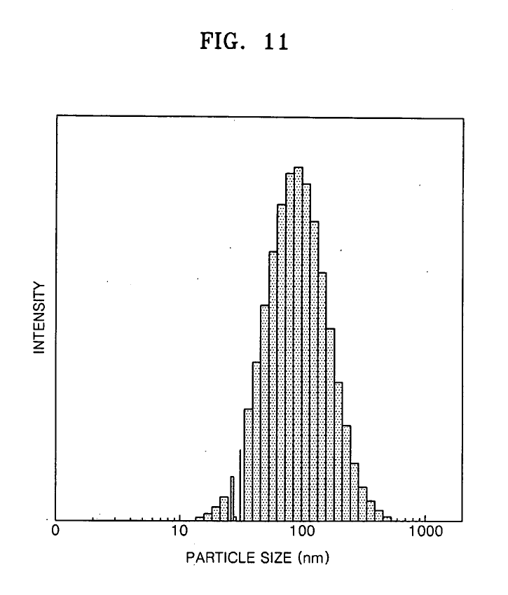

A TEM image and particle size distribution (average particle size: 106.3 nm) of the capsulated colorant prepared according to Example 1-15 are shown in FIGS. 10 and 11, respectively.

TABLE 4

| | Example 1-13 | Example 1-14 | Example 1-15 |
|---|---|---|---|
| Carbon black (g) | 10 | 10 | 10 |
| Styrene (g) | 2.5 | 2.5 | 2.5 |
| Butylacrylate (g) | 2.5 | 2.5 | 2.5 |
| KPS (g) | 0.05 | 0.05 | 0.05 |
| Water (g) | 100 | 100 | 100 |
| PEG-ethyl ether | 1.0 | — | — |
| methacrylate (g) | | | |
| PEG-polystyrene (g) | — | 1.0 | — |
| PEG-methacrylic | — | — | 1.0 |
| silicon (g) | | | |

Preparation of Capsulated Colorant not Using Macromonomer

### COMPARATIVE EXAMPLES 1-1 TO 1-9

Capsulated colorants were prepared in the same manner as in Examples 1-1 to 1-15 as listed in Table 5 below, except that emulsifiers, i.e., sodium dodecylsulfate (SDS), sodium dodecylbenzene sulfonate (NaDDBS), and cetyltrimethylammonium bromide (CTAB) were used instead of the macromonomer.

TABLE 5

| | Comparative | Comparative | Comparative | Comparative | Comparative | Comparative | Comparative | Comparative | Comparative |
|---|---|---|---|---|---|---|---|---|---|
| | Example | Example | Example | Example | Example | Example | Example | Example | Example |
| | 1-1 | 1-2 | 1-3 | 1-4 | 1-5 | 1-6 | 1-7 | 1-8 | 1-9 |
| Carbon black (g) | 10.0 | 10.0 | 10.0 | 10.0 | 10.0 | 10.0 | 10.0 | 10.0 | 10.0 |
| Styrene (g) | 2.2 | 4.4 | 3.0 | 2.2 | 1.8 | 2.2 | 2.2 | 2.2 | 2.2 |
| Butylacrylate (g) | 2.2 | 4.4 | 3.0 | 2.2 | 1.8 | 2.2 | 2.2 | 2.2 | 2.2 |
| KPS (g) | 0.0 | 0.1 | 0.1 | 0.1 | 0.0 | 0.1 | 0.1 | 0.1 | 0.1 |
| Water (g) | 100.0 | 100.0 | 100.0 | 100.0 | 100.0 | 100.0 | 100.0 | 100.0 | 100.0 |
| SDS (g) | 0.2 | 0.2 | 0.2 | 0.2 | 0.2 | 0.2 | 0.2 | 0.0 | 0.0 |
| NaDDBs | 0.0 | 0.0 | 0.0 | 0.0 | 0.0 | 0.0 | 0.0 | 0.04 | 0.0 |
| (g) | | | | | | | | | |
| CTAB (g) | 0.0 | 0.0 | 0.0 | 0.0 | 0.0 | 0.0 | 0.0 | 0.0 | 0.04 |

Preparation of Ink Composition

The capsulated colorants prepared according to Examples 1-1 to 1-15, water, an organic solvent, and additives were mixed as listed below, and the mixtures were sufficiently stirred in a stirrer for more than 30 minutes to a homogenized state. Then, the mixtures were passed through a 0.45 μm filter to prepare ink compositions of Examples 2-1 to 2-15.

### EXAMPLES 2-1 TO 2-5

| | |
|---|---|
| Capsulated colorant (Examples 1-1 to 1-5) | 4.5 parts by weight |
| Glycerol | 7.5 parts by weight |
| Diethylene glycol | 8 parts by weight |
| Water (deionized water) | 79 parts by weight |

### EXAMPLES 2-6 TO 2-15

| | |
|---|---|
| Capsulated colorant | 4.5 parts by weight |
| (Examples 1-6 to 1-15) | |
| Glycerol | 7.5 parts by weight |
| Diethylene glycol | 8 parts by weight |
| Nonionic surfactant | 0.6 parts by weight |
| (Surfynol465, Air Products & Chemicals) | |
| Water (deionized water) | 79 parts by weight |

The capsulated colorants prepared according to Comparative Examples 1-1 to 1-9, water, an organic solvent, and additives were mixed as listed below, and the mixtures were sufficiently stirred in a stirrer for more than 30 minutes to a homogenized state. Then, the mixtures were passed through a 0.45 μm filter to prepare ink compositions of Comparative Examples 2-1 to 2-9.

### COMPARATIVE EXAMPLES 2-1 TO 2-5

| | |
|---|---|
| Capsulated colorant | 4.5 parts by weight |
| (Comparative Examples 1-1 to 1-5) | |
| Glycerol | 7.5 parts by weight |
| Diethylene glycol | 8 parts by weight |
| Water (deionized water) | 79 parts by weight |

### COMPARATIVE EXAMPLES 2-6 TO 2-9

| | |
|---|---|
| Capsulated colorant | 4.5 parts by weight |
| (Comparative Examples 1-6 to 1-9) | |
| Glycerol | 7.5 parts by weight |
| Diethylene glycol | 8 parts by weight |
| Nonionic surfactant | 0.6 parts by weight |
| (Surfynol465, Air Products & Chemicals) | |
| Water (deionized water) | 79 parts by weight |

### EXPERIMENTAL EXAMPLE 1

### Cartridge Storage Stability Test

The degree of nozzle blocking was measured when printing was performed after storing each of the ink compositions prepared according to Examples 2-1 to 2-15 and Comparative Examples 2-1 to 2-9 in an ink cartridge of Samsung Corporation at room temperature (25° C.) and a low temperature (−5° C.) for 2 weeks. The results are shown in Table 6.

⊚: 10% or less nozzles were blocked.

◯: 10-20% nozzles were blocked.

Δ: 20-30% nozzles were blocked.

X: 31% or more nozzles were blocked.

### EXPERIMENTAL EXAMPLE 2

### Test of Storage Stability of Ink—Viscosity

Each of the ink compositions prepared according to Examples 2-1 to 2-15 and Comparative Examples 2-1 to 2-9 were stored in an ink cartridge of Samsung Corporation at a high temperature (60° C.) and a very low temperature (−18° C.) for 4 weeks. Then, viscosity was compared with initial viscosity and the difference in viscosity was measured. The results are shown in Table 6

⊚: 10% or less change in average rate of viscosity

◯: 11-20% change in average rate of viscosity

Δ: 21-30% change in average rate of viscosity

X: 31% or more change in average rate of viscosity

### EXPERIMENTAL EXAMPLE 3

### Test of Storage Stability of Ink—Surface Tension

Each of the ink compositions prepared according to Examples 2-1 to 2-15 and Comparative Examples 2-1 to 2-9 were stored in an ink cartridge of Samsung Corporation at a high temperature (60° C.) and a very low temperature (−18° C.) for 4 weeks. Then, surface tension was compared with initial surface tension, and the difference in surface tension was measured. The results are shown in Table 6.

⊚: 5% or less change in average rate of surface tension

◯: 6-10% change in average rate of surface tension

Δ: 11-20% change in average rate of surface tension

X: 21% or more change in average rate of surface tension

### EXPERIMENTAL EXAMPLE 4

### Foam Resistance Test

50 ml of each of the ink compositions prepared according to Examples 2-1 to 2-15 and Comparative Examples 2-1 to 2-9 was added to a cylinder, and 200 ml of the ink compositions were dropped from 1 m high into the cylinder. The volume of foam generated in the cylinder was measured, and the results are shown in Table 6 below.

⊚: 0≦volume of foam<30 ml

◯: 30 ml≦volume of foam<60 ml

Δ: 60 ml≦volume of foam<110 ml

X: 100≦volume of foam

### EXPERIMENTAL EXAMPLE 5

### Abrasion Resistance Test

Each of the ink compositions prepared according to Examples 2-1 to 2-15 and Comparative Examples 2-1 to 2-9 were refilled into an M-50 ink cartridge (Samsung Corporation), and a bar pattern (2×10 cm) was printed using a printer (MJC-3300p, Samsung Corporation). The printed resultant was dried for 24 hours. After the bar pattern was rubbed five times using a tester, optical density (OD) of an image transferred from the bar pattern was compared with OD of the original bar pattern, and the difference was represented as a percentage. The results are shown in Table 6.

A (OD of transferred image/OD of original bar pattern)*100(%)

⊚: A<15

◯: 15≦A<30

Δ: 30≦A≦45

X: A>45

### EXPERIMENTAL EXAMPLE 6

### Waterfastness Test

Each of the ink compositions prepared according to Examples 2-1 to 2-15 and Comparative Examples 2-1 to 2-9 was refilled into an M-50 ink cartridge (Samsung Corporation), and a bar pattern (2×10 cm) was printed using a printer (MJC-2400C, Samsung Corporation). After 5 minutes, 5 droplets of water were dropped onto the bar pattern, and then the printed resultant was dried for 24 hours. Then, a reduced OD of the image, after water flow thereon, was compared with OD of the original bar pattern, and the difference was represented as a percentage. The results are shown in Table 6.

A=(OD of image after water flew thereon/OD of original bar pattern)×100(%)

⊚: 95≦A

◯: 90≦A<95,

Δ: 85≦A<90

X: A<85

### EXPERIMENTAL EXAMPLE 7

### Optical Density (OD) Test

Each of the ink compositions prepared according to Examples 2-1 to 2-15 and Comparative Examples 2-1 to 2-9 was refilled into an M-50 ink cartridge (Samsung Corporation), and a bar pattern (2×10 cm) was printed using a printer (MJC-3300p, Samsung below, and the results are shown in Table 6.

A=OD of image

⊚: A≧1.4

◯: 1.2≦A<1.4

Δ: 1.0≦A<1.2

X: A<1.0

TABLE 6

| | | | Storage | | | | |
|---|---|---|---|---|---|---|---|
| | Cartridge | Storage | stability- | | | | |
| | storage | stability- | surface | Foam | Abrasion | | Optical |
| | stability | viscosity | tension | resistance | resistance | Waterfastness | density |
| Example | ⊚ | ⊚ | ⊚ | ⊚ | ⊚ | ⊚ | ⊚ |
| 2-1 | | | | | | | |
| Example | ⊚ | ◯ | ⊚ | ⊚ | ⊚ | ⊚ | ⊚ |
| 2-2 | | | | | | | |
| Example | ⊚ | ⊚ | ⊚ | ⊚ | ⊚ | ◯ | ◯ |
| 2-3 | | | | | | | |
| Example | Δ | Δ | ◯ | ◯ | ⊚ | ⊚ | ◯ |
| 2-4 | | | | | | | |
| Example | ◯ | Δ | Δ | Δ | ⊚ | ⊚ | ⊚ |
| 2-5 | | | | | | | |
| Example | ◯ | ◯ | ⊚ | ⊚ | ◯ | ⊚ | Δ |
| 2-6 | | | | | | | |
| Example | ⊚ | ⊚ | ⊚ | ⊚ | ⊚ | ⊚ | ⊚ |
| 2-7 | | | | | | | |
| Example | ⊚ | ◯ | ⊚ | ⊚ | ⊚ | ⊚ | ⊚ |
| 2-8 | | | | | | | |
| Example | ⊚ | ⊚ | ⊚ | ⊚ | ⊚ | ◯ | ◯ |
| 2-9 | | | | | | | |
| Example | ⊚ | ◯ | ⊚ | ⊚ | ⊚ | ⊚ | ⊚ |
| 2-10 | | | | | | | |
| Example | ◯ | ⊚ | ⊚ | ⊚ | ⊚ | ⊚ | ⊚ |
| 2-11 | | | | | | | |
| Example | ◯ | ⊚ | ◯ | ⊚ | ⊚ | ◯ | ⊚ |
| 2-12 | | | | | | | |
| Example | ⊚ | ⊚ | ⊚ | ⊚ | ⊚ | ⊚ | Δ |
| 2-13 | | | | | | | |
| Example | ⊚ | ◯ | ◯ | ◯ | ⊚ | ⊚ | ⊚ |
| 2-14 | | | | | | | |
| Example | ⊚ | ⊚ | ◯ | ⊚ | ⊚ | ◯ | ⊚ |
| 2-15 | | | | | | | |
| Comparative | Δ | X | Δ | Δ | ⊚ | ⊚ | ◯ |
| Example | | | | | | | |
| 2-1 | | | | | | | |
| Comparative | X | Δ | X | X | ⊚ | ⊚ | ◯ |
| Example | | | | | | | |
| 2-2 | | | | | | | |
| Comparative | ◯ | X | Δ | Δ | ◯ | ⊚ | ⊚ |
| Example | | | | | | | |
| 2-3 | | | | | | | |
| Comparative | Δ | X | Δ | ◯ | ⊚ | ◯ | Δ |
| Example | | | | | | | |
| 2-4 | | | | | | | |
| Comparative | X | ◯ | ◯ | ◯ | ⊚ | ⊚ | ⊚ |
| Example | | | | | | | |
| 2-5 | | | | | | | |
| Comparative | Δ | X | Δ | Δ | ⊚ | ◯ | ⊚ |
| Example | | | | | | | |
| 2-6 | | | | | | | |
| Comparative | Δ | X | Δ | Δ | ⊚ | ⊚ | ◯ |
| Example | | | | | | | |
| 2-7 | | | | | | | |
| Comparative | X | ◯ | ⊚ | ⊚ | ◯ | ⊚ | Δ |
| Example | | | | | | | |
| 2-8 | | | | | | | |
| Comparative | ◯ | Δ | ⊚ | ⊚ | ⊚ | ◯ | ⊚ |
| Example | | | | | | | |
| 2-9 | | | | | | | |

Referring to Table 6, ink compositions including capsulated colorants prepared using macromonomers according to Examples 2-1 to 2-15 exhibit better cartridge storage stability, ink storage stabilize, foam resistance, waterfastness, abrasion resistance, and optical density, compared to ink compositions prepared without using macromonomers, which is shown in Comparative Examples 2-1 to 2-9

Such physical properties as described above can be derived by using the macromonomer when the capsulated colorant is prepared using the polymerizable unsaturated monomer. The macromonomer is co-polymerized with the polymerizable unsaturated monomer to form permanent chemical bonds, thereby permanently maintaining dispersion stability of an emulsion obtained by the result of the polymerization. The macromonomer eliminates interaction between the organic solvent and the emulsifier which are used to prepare ink, thereby maintaining stable physical properties for a long period of time, and inhibits foam generation.

A colorant, which has permanent dispersion stability and does not have a residual emulsifier, can be prepared using a water-soluble macromonomer including an unsaturated hydrocarbon as an emulsifier when a polymer encapsulates the surface of the colorant using polymerization. By using an ink composition including the colorant, a printed image can have excellent waterfastness, light resistance, abrasion resistance, and optical density properties, and ink can be reliable with respect to storage stability and prevention of nozzle blocking.

While present structures and compositions have been shown and described, it will be understood that various changes in form and details may be made therein without departing from the spirit and scope as defined by the following claims.

What is claimed is:

1. A capsulated colorant comprising: a colorant; and a polymer resin coating the colorant, wherein the polymer resin is a result of polymerization of a polymerizable composition comprising a macromonomer and a polymerizable unsaturated monomer.

2. The capsulated colorant of claim 1, wherein the macromonomer is a water-soluble polymer comprising an unsaturated hydrocarbon.

3. The capsulated colorant of claim 1, wherein the amount of macromonomer is about 1 to about 150 parts by weight based on 100 parts by weight of the polymerizable unsaturated monomer.

4. The capsulated colorant of claim 1, wherein the polymerizable unsaturated monomer is at least one selected from the group consisting of: a compound having at least two double bonds, an unsaturated carboxylic acid, a vinyl cyanide monomer, an unsaturated carboxylic acid alkyl ester, an unsaturated carboxylic acid hydroxyalkyl ester, an unsaturated carboxylic acid amide, an aromatic vinyl monomer, a vinyl lactam, a methyl vinyl ketone, a vinylidene chloride, an unsaturated amine, an unsaturated pyridine, an unsaturated azole, and derivatives thereof.

5. The capsulated colorant of claim 1, wherein the macromonomer is at least one selected from the group consisting of: an unsaturated polyethylene glycol-based compound, an unsaturated polyester-based compound, an unsaturated acrylate-based compound, an unsaturated polyamide-based compound, an unsaturated epoxy resin-based compound, an unsaturated polystyrene-based compound, and an unsaturated fatty acid-based compound.

6. The capsulated colorant of claim 1, wherein the macromonomer is at least one selected from the group consisting of: polyethylene glycol (PEG)-methacrylate, polyethylene glycol (PEG)-ethyl ether methacrylate, polyethylene glycol (PEG)-polystyrene, polyethylene glycol (PEG)-methacrylic silicon, polyethylene glycol (PEG)-dimethacrylate, polyethylene glycol (PEG)-modified urethane, polyethylene glycol (PEG)-modified polyester, polyacryl amide (PAM), polyethylene glycol (PEG)hydroxyethyl methacrylate, hexafunctional polyester acrylate, dendritic polyester acrylate, carboxy polyester acrylate, fatty acid modified epoxy acrylate, and polyester methacrylate.

7. A method of preparing a capsulated colorant, the method comprising:
emulsifying a polymerization composition comprising a polymerizable unsaturated monomer, a water-soluble medium, a colorant, a macromonomer, and a polymerization initiator; and
forming a polymer resin coating on the colorant by polymerizing the polymerizable unsaturated monomer and the macromonomer on the colorant.

8. The method of claim 7, wherein the polymerization composition comprises about 1 to about 150 parts by weight of the macromonomer, about 500 to about 5,000 parts by weight of the water-soluble medium, about 100 to about 300 parts by weight of the colorant, and about 1 to about 30 parts by weight of the polymerization initiator, based on 100 parts by weight of the polymerizable unsaturated monomer.

9. An ink composition comprising:
a colorant;
a polymer resin coating the colorant, and
a solvent,
wherein the polymer resin is a result of polymerization of a polymerizable composition comprising a macromonomer and a polymerizable unsaturated monomer.

10. The ink composition of claim 9, wherein the amount of the encapsulated colorant is in the range of about 1 to about 20 parts by weight, and the amount of the solvent is in the range of about 80 to about 99 parts by weight based on 100 parts by weight of the ink composition.

11. The ink composition of claim 9, wherein the solvent comprises at least one organic solvent selected from the group consisting of a monohydric alcohol-based solvents a ketone-based solvent, an ester-based solvent, a polyhydric alcohol-based solvent, a nitrogen-containing solvent, and a sulfur-containing solvent, and water.

12. The ink composition of claim 9, having a surface tension of about 15 to about 70 dyne/cm and a viscosity of about 1 to about 20 cps at about 20° C.

13. An ink set comprising at least two types of ink compositions according to claim 9.

14. A cartridge for an inkjet recording apparatus comprising the ink set of claim 13.

15. An inkjet recording apparatus comprising the cartridge of claim 14.
